(19) United States
(12) Patent Application Publication
(10) Pub. No.: US 2022/0159972 A1
(43) Pub. Date: May 26, 2022

(54) RODENTICIDE

(71) Applicant: INNOVAZIONE E SVILUPPO SOSTENIBILE S.R.L., TORINO(TO) (IT)

(72) Inventor: Guglielmo BUONAMICI, SAN GIULIANO TERME (Pisa) (IT)

(73) Assignee: INNOVAZIONE E SVILUPPO SOSTENIBILE S.R.L., TORINO (TO) (IT)

(21) Appl. No.: 17/440,963

(22) PCT Filed: Mar. 20, 2020
(86) PCT No.: PCT/IB2020/052634

§ 371 Date: Sep. 20, 2021

(30) Foreign Application Priority Data
Mar. 21, 2019 (IT) 102019000004147

(51) Int. Cl. A01N 65/34; A01N 65/12; A01N 63/50; A01N 63/36; A01P 11/00

(52) U.S. Cl. CPC A01N 65/34; A01N 65/12; A01P 11/00; A01N 63/36; A01N 63/50

(57) ABSTRACT

A rodenticide is provided, including extracts of: Aesculus hippocastanum, Prunus laurocerasus, Digitalis purpurea, Melilotus officinalis, Ricinus communis, Salix alba, egg albumin, and Penicillium chrysogenum.

### RODENTICIDE

This invention relates to a rodenticide of the type specified in the preamble of the first claim.

In particular, this invention relates to a pesticide used to kill or eliminate the presence or action of rodents. To be precise, the invention relates to a pesticide for mice, i.e. a rat-poison.

Currently, rodenticides and, in particular, rat-poisons are chemical and mainly based on thallium that produces severe cellular toxicity and zinc phosphide, a substance that releases amounts of highly toxic phosphine gas, in contact with the gastric mucosa, which affects the brain, kidneys, heart, and liver.

The described prior art comprises some significant drawbacks.

In particular, known rodenticides are not very biodegradable and are, therefore, particularly persistent. This results in significant pollution of the application areas, and those adjacent to them.

This drawback is increased by the high toxicity of rodenticides that, when in contact with plants or other animals, may have carcinogenic, mutagenic, and/or teratogenic effects. For this reason, known rodenticides require scrupulous application protocols and, especially for those with greater strength, can only be used by qualified professionals.

In this context, the technical task underlying this invention is to devise a rodenticide that is capable of substantially overcoming at least some of the above-mentioned drawbacks.

In the context of said technical task, an important purpose of the invention is to obtain a rodenticide with a low environmental impact and that, therefore, is simpler to use.

The technical task and the specified purposes are achieved by means of rodenticide as claimed in the appended claim 1. Examples of preferred embodiments are described in the dependent claims.

In the present document, the measures, values, shapes, and geometric references (such as perpendicularity and parallelism), when associated with words like “almost” or other similar terms such as “approximately” or “substantially”, are to be understood as except for measurement errors or inaccuracies owing to production and/or manufacturing errors and, above all, except for a slight divergence from the value, measure, shape, or geometric reference with which it is associated. For example, if associated with a value, such terms preferably indicate a divergence of no more than 10% of the value itself.

The measurements and data provided in the present text are to be considered as performed in ICAO International Standard Atmosphere (ISO 2533), unless otherwise indicated.

The rodenticide according to the invention is designed to be used to kill rodents, in particular mice, and preferably Mus musculus and Rattus rattus. It is, therefore, a rat-poison.

The rodenticide comprises one or more phyto-complexes appropriately chosen from the following: Aesculus hippocastanum, Prunus laurocerasus, Digitalis purpurea, Melilotus officinalis, Atropa belladonna, Ricinus communis, Salix alba, and egg albumin.

Specifically, it comprises Aesculus hippocastanum extracts and, more specifically, Aesculus hippocastanum seed extracts.

The content of Aesculus hippocastanum extracts is substantially between 20% and 5%, specifically between 15% and 5%, more specifically between 10% and 5%, and even more specifically between 9% and 8%. It is basically 8.6%.

The content of the rodenticide's various components is determined as a ratio between the component's weight and the rodenticide's total weight.

Aesculus hippocastanum extracts are capable of producing toxic actions in large and small mammals. They comprise aescin that is capable of high toxic action in small mammals.

Aesculus hippocastanum extracts comprise antithrombotic coumarins.

Aesculus hippocastanum extracts comprise glycosides.

Aesculus hippocastanum extracts comprise acylated triterpenes and, specifically, protoescigenin, barringtogenol C, glucuronic acid, quercetin, and vitamin (factor) P. The rodenticide comprises Prunus laurocerasus extracts and, specifically, Prunus laurocerasus leaf extracts.

The content of Prunus laurocerasus extracts is approximately lower than the content of Aesculus hippocastanum extracts. It is approximately less than 5%, specifically than 2%, and more specifically than 1%. The content of Prunus laurocerasus extracts is preferably substantially between 1% and/or 0.5% and, appropriately, substantially 0.6%.

Prunus laurocerasus extracts comprise laurocerasin.

Prunus laurocerasus extracts comprise hydrocyanic acid.

The rodenticide comprises Digitalis purpurea extracts and, specifically, Digitalis purpurea leaf extracts.

The content of Digitalis purpurea extracts is higher than that of Aesculus hippocastanum extracts. It is somewhere between 40% and 10%, specifically between 30% and 20%, more specifically between 30% and 25%, even more specifically between 29% and 27%. The content of Prunus laurocerasus extracts is substantially 28.6%.

Digitalis purpurea extracts comprise digitalin and/or digoxin.

These extracts comprise one or more and, specifically, all of the following: cardenolides containing digitalin, gitaloxygenin, and gitaloxin; saponins comprising digitonoside, gitonoside, and tigonoside; digitanol-heterosides comprising diginoside and tigifolein; flavonoids comprising luteolin, ascorbic acid, citric acid, caffeic acid, and p-coumaric acid.

The rodenticide comprises Melilotus officinalis extracts and, specifically, Melilotus officinalis flower top extracts.

The content of Melilotus officinalis extracts is lower than that of Aesculus hippocastanum. It is substantially between 10% and 1%, specifically between 5% and 1%, more specifically between 4% and 2%, and even more specifically between 3% and 2.5%. The content of Melilotus officinalis extracts is approximately 2.8%. The Melilotus officinalis extracts comprise coumarin antagonists of the blood-clotting process.

The Melilotus officinalis extracts comprise melilotoside and/or coumarigenin. The rodenticide comprises Ricinus communis extracts and, specifically, Ricinus communis seed extracts.

The content of Ricinus extracts is lower than that of Aesculus hippocastanum. It is approximately less than 1%, specifically than 0.1%, and more specifically than 0.05%. The content of Ricinus communis extracts is substantially 0.001%.

Ricinus communis extracts comprise glycoproteins and, specifically, ricin, ricinoleic acid, and ricinolein.

The rodenticide comprises Salix alba extracts and, specifically, Salix alba bark extracts.

The content of Salix alba extracts is lower than that of Aesculus hippocastanum extracts and preferably equal to the content of Melilotus officinalis. It is approximately between 10% and 1%, specifically between 5% and 1%, more specifically between 4% and 2%, and even more specifically between 3% and 2.5%.

The content of Salix alba extracts is substantially 2.8%.

Salix alba extracts comprise acetylsalicylic acid that acts to block the formation of thromboxane A2 in platelets.

The rodenticide comprises egg albumin and, specifically, egg albumin extracts. The content of egg albumin is lower than that of the Aesculus hippocastanum extracts and preferably equal to the content of Melilotus officinalis. It is approximately between 10% and 1%, specifically between 5% and 1%, more specifically between 4% and 2%, and even more specifically between 3% and 2.5%.

The content of egg albumin extracts is approximately 2.8%.

The egg albumin extracts comprise plasma proteins.

The rodenticide may comprise Atropa belladonna extracts and, specifically, Atropa belladonna leaf extracts.

The content of Atropa belladonna extracts is lower than that of Aesculus hippocastanum extracts and preferably equal to the content of Melilotus officinalis. It is approximately between 10% and 1° A, specifically between 5% and 1%, more specifically between 4% and 2%, and even more specifically between 3% and 2.5%. The content of Atropa belladonna extracts is substantially 2.8%.

The Atropa belladonna extracts comprise atropine, scopolamine, and L-hyoscyamine.

The rodenticide comprises one or more fungi appropriately chosen from the following: Aspargillus niger, Fucus vesiculosus, and Penicillium, preferably selected from Penicillium brefeldianum, Penicillium notatum, and Penicillium chrysogenum. The rodenticide comprises Penicillium extracts and, specifically, a content of Penicillium extracts substantially between 40% and 15%, specifically between 35% and 20%, and more specifically between 30% and 25%.

The rodenticide comprises Penicillium extracts and, specifically, a content of Penicillium extracts substantially between 40% and 15%, specifically between 35% and 20%, and more specifically between 30% and 25%.

The content of Penicillium chrysogenum extracts is lower than that of Aesculus hippocastanum extracts. It is substantially between 10% and 1%, specifically between 8% and 3%, and more specifically between 6% and 4%.

Penicillium chrysogenum extracts comprise penicillin.

The Penicillium extracts may comprise Penicillium brefeldianum extracts.

The content of Penicillium brefeldianum extracts is lower than that of Aesculus hippocastanum extracts and, appropriately, approximately equal to the content of Penicillium chrysogenum. It is approximately between 10% and 1%, specifically between 8% and 3%, and more specifically between 6% and 4%.

The Penicillium brefeldianum extracts comprise macrocyclic lactone and brefeldin. The Penicillium extracts may comprise Penicillium notatum extracts.

The content of Penicillium notatum extracts is lower than that of Aesculus hippocastanum extracts and, appropriately, approximately equal to the content of Penicillium chrysogenum. It is substantially between 10% and 1%, specifically between 8% and 3%, and more specifically between 6% and 4%.

The Penicillium chrysogenum extracts comprise xanthocillin antibiotic.

Rodenticide may comprise Fucus vesiculosus extracts.

The content of Fucus vesiculosus extracts is higher than that of Aesculus hippocastanum extracts. It is substantially between 25% and 5%, specifically between 20% and 10%, and more specifically between 15% and 11%.

Fucus vesiculosus extracts comprise alginic acid.

Finally, the rodenticide may comprise at least one compound palatable to rodents, particularly a mouse, and more particularly Mus musculus or Rattus rattus.

The palatable compound is a liquid or preferably solid food (e.g. dairy, vegetable/fruit, or meat) that attracts the rodent making it wish to eat and/or drink and, therefore, to take the rodenticide.

The following is a non-exhaustive example of the formulation of a 35 g sample of rodenticide comprising, in addition to said at least one palatable compound, the following contents of the various extracts: 3 g Aesculus hippocastanum, 0.2 g Prunus laurocerasus, 10 g Digitalis purpurea, 1 g Melilotus officinalis (with, appropriately, 0.02 g Aspargillus niger), 0.003 g Ricinus communis, 1 g Salix alba, 1 g egg albumin, and 1.5 g to 2 g Penicillium chrysogenum. In addition, it may comprise at least one and, specifically, all of the following extracts: 1 g Atropa belladonna, 4 to 5 g Fucus vesiculosus, 1.5 to 2 g Penicillium notatum, and 1.5 to 2 g Penicillium brefeldianum.

The above-described extracts (phyto-complexes and/or fungi) can be obtained through a drying and titration process of the powders or by solvent extraction.

In some cases, they can be obtained by Soxhlet reflux extraction and, in particular, with ultrasound or supercritical gas, and the addition of sulphur dioxide as the solvent. Preferably, these extracts are obtained through the Soxhlet reflux method with methanol. This method comprises the fermentation and hydrolysis of the part of the plant (for example fruit, flower or leaf) from which the extracts are to be obtained, with the addition of yeast, appropriately Saccharomycetaceae (such as Saccharomyces cerevisiae) and preferably operating at pH 7 for about 4 days; evaporation and centrifugation to remove the solvent from the solution obtained above; Soxhlet extraction; methanol removal by boiling-point heating, and extraction thereof by evaporation.

The rodenticide according to the invention entails important advantages.

In fact, the rodenticide that this invention relates to is completely biological because its toxic agents are of vegetable extraction only.

Unlike the known ones, this rodenticide is exclusively composed of vegetable components, is, therefore, totally biodegradable and, therefore, has almost no environmental impact. As a result, this rodenticide can be used almost anywhere since there is no risk of pollution in application areas and those adjacent to it. Another advantage is that this rodenticide does not require application protocols. An important advantage lies in the high activity of the rodenticide that is guaranteed by the particular combination of phyto-complexes and fungi, as demonstrated by the inventor's studies. In particular, this innovative combination of extracts gives the rodenticide a strong cardiovascular-respiratory action that leads to the quick death of the rodent.

In fact, the particular selection of fungi and phyto-complexes gives the rodenticide an extraordinary biocidal action carried out by the wide-ranging antibiotics contained in them, altering the normal intestinal flora that induce a significant decrease in the production of vitamin K that, in turn, causes painless haemorrhages in the murine population causing death.

In particular, the cardiovascular action (caused by the synergistic action of the extracts of: Aesculus hippocastanum, Digitalis purpurea, Melilotus officinalis, Ricinus communis, Salix alba, egg albumin, and Penicillium chrysogenum, and, appropriately, Aspargillus niger) is combined with the respiratory action (caused by the extracts of: Prunus laurocerasus, Ricinus communis, Fucus vesiculosus, and Atropa belladonna) making the rodenticide extraordinarily effective.

In fact, studies have shown that the Aesculus hippocastanum extracts have a strong antithrombotic action and inhibition of vitamin K synthesis leading to acute internal haemorrhages.

This vitamin K action is synergistically assisted by the Melilotus officinalis extracts that, being rich in coumarins (antagonists of the blood-clotting process), block the vitamin K synthesis.

In addition, the presence of Aspargillus niger, which in turn strengthens the action of the Melilotus officinalis extracts, lengthens the blood coagulation times in contrast to the blood coagulation and vitamin K synthesis.

The haemorrhagic action of the Aesculus hippocastanum and Melilotus officinalis extracts is enhanced by the egg albumin and, appropriately, Salix alba extracts that, by interfering with the platelet function, favour the haemorrhagic action of the Aesculus hippocastanum extracts; and by the Digitalis purpurea extracts that, being extremely rich in digitalin and digoxin, lead to acute forms of arrhythmia and cardiovascular block.

The cardiovascular action of the rodenticide is completed by the Ricinus communis extracts that, being rich in ricin, damage the red blood cells. These blood cells, due to the haemorrhagic crisis, are almost incapable of bringing oxygen to the organs, considerably straining the respiratory system.

This respiratory system strain is made more acute by the Prunus laurocerasus extracts that, in addition to causing balance disorders, convulsions, and rapid loss of consciousness, lead to respiratory arrest.

Variations may be made to the invention that fall within the scope of the inventive concept defined in the claims. All details may be replaced with equivalent elements and the scope of the invention includes all other materials, shapes, and dimensions.

1. A rodenticide comprising extracts from: Aesculus hippocastanum, Prunus laurocerasus, Digitalis purpurea, Melilotus officinalis, Ricinus communis, Salix alba, egg albumin, and Penicillium chrysogenum.

2. The rodenticide according to claim 1, wherein the content of said Aesculus hippocastanum extracts is substantially comprised between 10% and 5%; the content of said Prunus laurocerasus extracts is substantially comprised between 1% and 0.5%; the content of said Digitalis purpurea extracts is substantially comprised between 30% and 25%; the content of said Melilotus officinalis extracts is substantially comprised between 5% and 1%; the content of said Ricinus communis extracts is substantially lower than 0.1%; the content of said Salix alba extracts is substantially comprised between 5% and 1%; the content of said egg albumin extracts is substantially comprised between 5% and 1%; and the content of said Penicillium chrysogenum extracts is substantially comprised between 8% and 3%.

3. The rodenticide according to claim 1, further comprising extracts from Atropa belladonna.

4. The rodenticide according to claim 3, wherein the content of said Atropa belladonna extracts is substantially between 5% and 1%.

5. The rodenticide according to claim 1, further comprising extracts from Fucus vesiculosus.

6. The rodenticide according to claim 5, wherein the content of said Fucus vesiculosus extracts is substantially comprised between 20% and 10%.

7. The rodenticide according to claim 1, comprising a content of Penicillium brefeldianum extracts substantially comprised between 8% and 3% and a content of Penicillium notatum extracts substantially comprised between 8% and 3%.

8. The rodenticide according to claim 1, comprising a compound palatable to rodents.

9. The rodenticide according to claim 2, further comprising extracts from Fucus vesiculosus.

10. The rodenticide according to claim 9, wherein the content of said Fucus vesiculosus extracts is substantially comprised between 20% and 10%.

11. The rodenticide according to claim 2, comprising a content of Penicillium brefeldianum extracts substantially comprised between 8% and 3% and a content of Penicillium notatum extracts substantially comprised between 8% and 3%.

12. The rodenticide according to claim 2, comprising a compound palatable to rodents.
